(19) United States
(12) Patent Application Publication
(10) Pub. No.: US 2014/0232246 A1
(43) Pub. Date: Aug. 21, 2014

(54) FAN MOTOR

(71) Applicant: Samsung Electro-Mechanics Japan Advanced Technology Co., Ltd., Shizuoka (JP)

(72) Inventors: Motoyuki SUGIURA, Shizuoka (JP); Futoshi YOSHIMATSU, Shizuoka (JP); Satoshi HATAHARA, Shizuoka (JP); Shunsuke TAKAGAKI, Shizuoka (JP)

(73) Assignee: Samsung Electro-Mechanics Japan Advanced Technology Co., Ltd., Shizuoka (JP)

(21) Appl. No.: 14/171,987

(22) Filed: Feb. 4, 2014

(30) Foreign Application Priority Data
Feb. 15, 2013 (JP) 2013-027424
Feb. 20, 2013 (JP) 2013-030585
Feb. 20, 2013 (JP) 2013-030586

(51) Int. Cl. H02K 7/08; H02K 5/15; H02K 11/00

(52) U.S. Cl. CPC H02K 7/08; H02K 11/0073; H02K 5/15
USPC 310/68 R; 310/90

(57) ABSTRACT

A fan motor includes: a rotor configured to be rotated so as to generate air movement; a stator configured to rotatably support the rotor via a fluid dynamic pressure bearing; and a driving mechanism configured to rotationally drive the rotor with respect to the stator. The rotor comprises a hub fixed to an impeller. The stator includes a bottom housing which supports a sleeve. The fan motor is configured to have a thickness of 3.2 mm or less along the rotational axis R of the rotor.

### BACKGROUND OF THE INVENTION

1. Field of the Invention

The present invention relates to a fan motor.

2. Description of the Related Art

Portable electronic devices such as laptop PCs (Personal Computers), tablet PCs, and the like, have been becoming popular. There is a demand for such portable electronic devices having a light weight and a small thickness, in addition to having high efficiency. In order to provide such portable electronic devices with high efficiency, such a portable electronic device may preferably mount a high-efficiency IC (Integrated Circuit) having a high computation capability CPU (Central Processing Unit), etc., which can be readily conceived. Typically, in this case, such a high-efficiency IC requires relatively large power consumption. Thus, there is a need to mount a cooling mechanism having higher heat releasing capability.

A fan motor which can be employed in such a cooling mechanism for such a portable electronic device is disclosed in Patent Application Laid Open No. 2006-34055 and Patent Application Laid Open No. 2011-179345.

### SUMMARY OF THE INVENTION

Such a fan motor has a non-negligible thickness, which can become a bottleneck in advancing the development of such a portable electronic device having a small thickness.

The present invention has been made in view of such a situation. Accordingly, it is a general purpose of the present invention to provide a fan motor which allows a device mounting the fan motor to be configured to have a small thickness or a small size.

An embodiment of the present invention relates to a fan motor. The fan motor comprises: a rotor configured to be rotated so as to generate air movement; a stator configured to rotatably support the rotor via a fluid dynamic pressure bearing; and a driving mechanism configured to rotationally drive the rotor with respect to the stator. The rotor comprises a hub fixed to a vane member. The stator comprises a base which supports the driving mechanism. The fan motor is configured to have a thickness of 3.2 mm or less along the rotational axis of the rotor.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a top view and a side view of a fan motor according to an embodiment;

FIG. 2 is a cross-sectional view taken along line A-A in FIG. 1;

FIG. 3 is a top view of six coreless flat coils arranged on an FPC;

FIG. 4 is a top view of the FPC fixed on a bottom housing;

FIG. 5 is a cross-sectional view of a bearing assembly shown in FIG. 2;

FIG. 6 is a top view of an upper layer;

FIG. 7 is a top view of a lower layer;

FIG. 8 is a half cross-sectional view of a fan motor including the bottom housing according to a first modification;

FIG. 9 is a top view of an upper layer of the bottom housing according to a second modification;

FIG. 10 is a bottom view of a lower layer of the bottom housing;

FIG. 11 is a perspective view of the bottom housing;

FIG. 12 is a cross-sectional view of the bottom housing mounting the FPC in the vicinity of a first through hole;

FIG. 13 is a top view of an upper layer of the bottom housing according to a third modification;

FIG. 14 is a bottom view of a lower layer of the bottom housing;

FIG. 15 is a perspective view of the bottom housing as viewed from the top side;

FIG. 16 is a perspective view of the bottom housing as viewed from the bottom side;

FIG. 17 is a half cross-sectional view of a bearing assembly, a shaft, and a hub, according to a fourth modification; and

FIG. 18 is a schematic diagram showing two fan motors mounted on a laptop PC according to an embodiment.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A fan motor according to an embodiment is mounted on a portable electronic device such as a laptop PC, tablet PC, and the like, and is preferably employed in order to cool electronic components such as ICs or the like.

First, description will be made regarding the outline of a fan motor according to the embodiment.

Conventionally, fan motors are configured to have a relatively large thickness in order to provide high ventilation capability. However, such a fan motor having such a relatively large thickness can become a bottleneck in advancing the development of such a portable electronic device having a small thickness. In contrast, a fan motor according to the present embodiment is configured as a centrifugal ventilation type multi-vane fan motor. The impeller of the fan motor is rotationally driven by means of a coreless and brushless magnetic driving mechanism. The magnetic driving mechanism has a flat coil configuration. During rotation, the impeller is supported in the radial direction (i.e., the direction that is orthogonal to the rotational axis of the impeller) by means of the fluid dynamic pressure bearing. Furthermore, the impeller is supported in the axial direction (i.e., the direction that is in parallel with the rotational axis of the impeller) by means of the pivot mechanism. By employing such a configuration, the fan motor according to the present embodiment is configured to have a thickness along the rotational axis of the impeller of 3.2 mm or less, and specifically, approximately 3.0 mm. As a result, such a fan motor is provided, which is suitably employed in portable electronic devices that are demanded to have a reduced thickness.

In many cases, typical fan motors mount an IC in the form of a package for driving and controlling a motor. In a case in which such an IC package is arranged on the path through which ventilation air passes, such an IC package can serve as a barrier which impedes the air flow. As the fan motor is configured to have a smaller thickness, the ratio of the thickness of the IC package with respect to the thickness of the fan motor becomes greater, and thus, the adverse effect of the IC package on the air flow becomes more pronounced. In contrast, the fan motor according to the present embodiment includes a hub fixed to an impeller, a base which supports a hub, and a driving IC which supplies electric power to a magnetic driving mechanism. The driving IC is arranged at a position that is more toward the inner side than is the impeller, and that avoids it being positioned in a region between the impeller and the base. With the centrifugal ventilation type fan motor, the driving IC is positioned outside the path of the air flow generated by the rotation of the impeller. This provides a fan motor which is capable of reducing or otherwise eliminating the adverse effect of the driving IC, which supplies electric power to the magnetic driving mechanism, on the air flow.

Also, typical fan motors include wiring which allows current to flow to the coils of the magnetic driving unit from an external power supply. Typically, the thickness of the fan motor is also determined by the thickness of the wiring. Thus, as the thickness of the fan motor becomes smaller, the ratio of the thickness of the wiring with respect to the thickness of the fan motor becomes greater. That is to say, the thickness of the wiring can become a bottleneck in the development of such a fan motor having a small thickness. In contrast, with the fan motor according to the present embodiment, a recess portion is provided to the base such that it extends along a wiring path for a flexible printed circuit board. The flexible printed circuit board is housed in the recess portion. As a result, this provides a fan motor which is capable of reducing or otherwise eliminating the limitation imposed on the development of such a fan motor having a small thickness due to the thickness of the flexible printed circuit board for transmitting electric power to be supplied to the magnetic driving mechanism configured to drive the fan motor.

Specific description will be made below regarding a fan motor according to an embodiment.

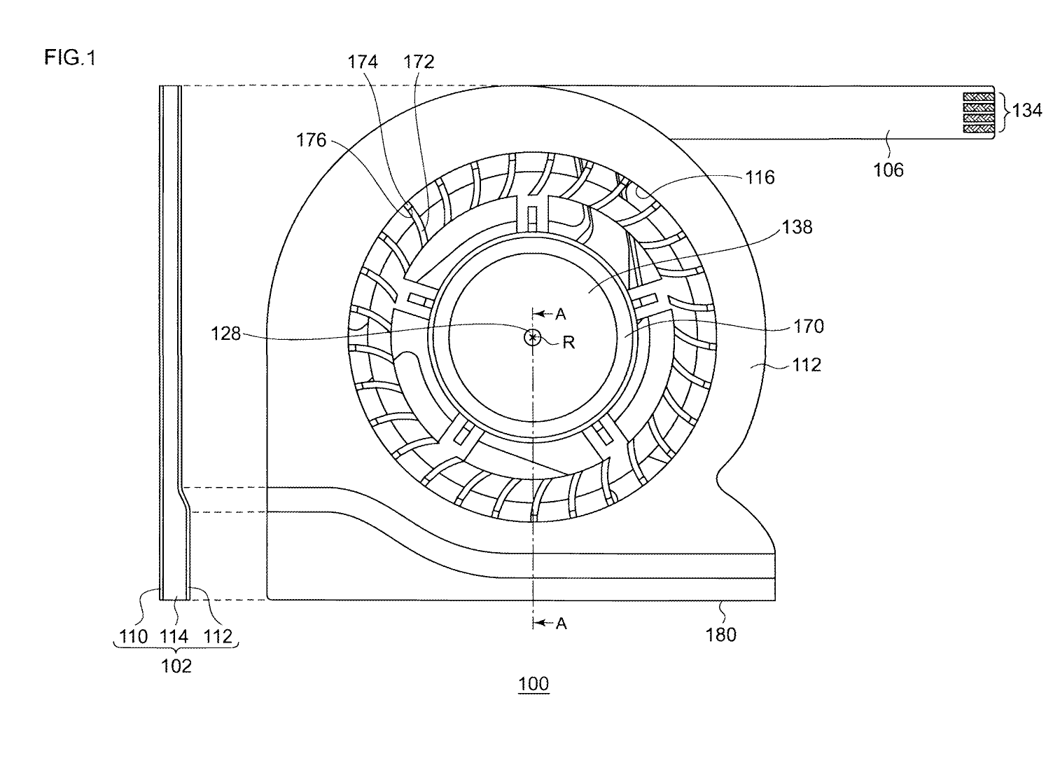

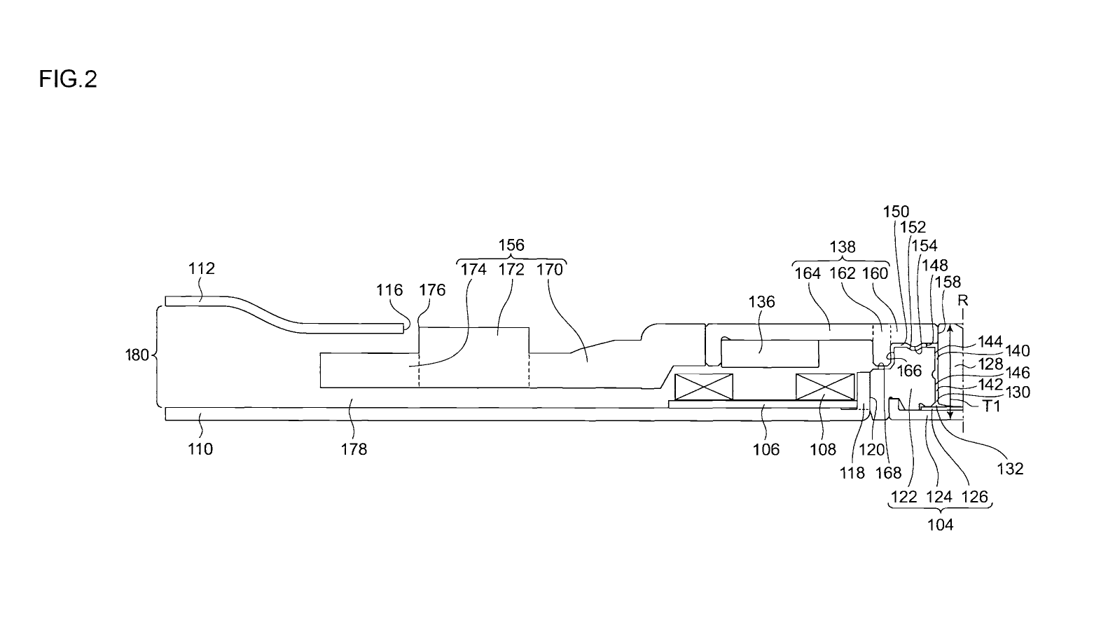

FIG. 1 shows a top view and a side view of a fan motor 100 according to the embodiment. FIG. 2 is a cross-sectional diagram taken along line A-A in FIG. 1. The fan motor 100 includes a rotor configured to be rotationally driven in order to blow air, a stator which rotatably supports the rotor via a fluid dynamic pressure bearing, and a magnetic driving mechanism which rotationally drives the rotor with respect to the stator.

The stator includes a housing 102 and a bearing assembly 104.

The housing 102 includes a bottom housing 110, a top housing 112, and a side housing 114. The bottom housing 110 and the top housing 112 are formed of a ferromagnetic plate such as an iron plate, silicon steel plate, or the like. The bottom housing 110 and the top housing 112 are arranged such that they face each other along the axial direction. The bottom housing 110 may be formed by pressing a cold rolled steel plate having a thickness of 0.4 mm, for example. A top opening 116 is formed in the top housing 112 such that its center approximately matches the rotational axis R.

The side housing 114 is mechanically bonded to the corresponding edge of the bottom housing 110 and the corresponding edge of the top housing 112 by means of an adhesive agent or the like. The side housing 114 supports the top housing 112 with the bottom housing 110 as a base. The bottom housing 110, the top housing 112, and the side housing 114 define a housing space 178 for housing the rotor.

The side housing 114 is configured to surround a part of the rotor. A region in which the side housing 114 does not surround the rotor functions as a vent 180 which communicates between the housing space 178 and the outside of the fan motor 100. During the rotation of the rotor, air passes through the vent 180, the top opening 116, and a bottom vent described later. In particular, the housing 102 has an approximately semi-circular shape as viewed in a plan view. Furthermore, the side housing 114 is provided to a portion that corresponds to the circumference of the semi-circular shape of the housing 102. However, the side housing 114 is not provided to a portion that corresponds to the chord of the semi-circular shape of the housing 102.

Description will be made below with the direction from the bottom housing 110 to the top housing 112 as the “upward direction”. The bottom housing 110 supports the bearing assembly 104. The bottom housing 110 has a bent portion 118 that protrudes upward and surrounds the rotational axis R. The bent portion 118 is formed by bending a portion of the bottom housing 110 upward. The bent portion 118 has a cylindrical shape. The inner face of the bent portion 118 defines a bearing hole 120 having a center that approximately matches the rotational axis R.

The bearing assembly 104 is inserted or fit into the bearing hole 120, and is fixed by adhesion, press fitting, or the like. The bearing assembly 104 includes a sleeve 122, a cover 124, and a thrust plate 126.

The sleeve 122 is formed by cutting a brass base material. It should be noted that the sleeve 122 may be formed of a steel material such as SUS430. After the cutting, the surface of the sleeve 122 is subjected to electroless nickel plating. In order to provide a base layer for the electroless nickel plating, strike plating may be performed, for example.

The sleeve 122 is configured to surround a shaft 128 described later with a radial bearing gap 130. A lubricant agent 132 is injected into a gap, including the radial bearing gap 130, between the rotor and the stator. The outer face of the sleeve 122 is fixed to the inner face of the bent portion 118 by means of adhesion or press fitting, or otherwise both.

The radial bearing gap 130 has two radial dynamic pressure generating portions 140 and 142 configured to apply radial dynamic pressure to the lubricant agent 132 along the radial direction when the shaft 128 is rotated with respect to the sleeve 122. The two radial dynamic pressure generating portions 140 and 142 are arranged as separate portions at a predetermined interval along the axial direction. Specifically, the first radial dynamic pressure generating portion 140 is arranged above the second radial dynamic pressure generating portion 142. With such an arrangement, a first radial dynamic pressure generating groove 144 and a second radial dynamic pressure generating groove 146, each having a herringbone structure or a spiral structure, are formed at the respective portions of the inner face of the sleeve 122 that correspond to the two radial dynamic pressure generating portions 140 and 142. It should be noted that at least one of the first radial dynamic pressure generating groove 144 and the second radial dynamic pressure generating groove 146 may be formed in the outer face of the shaft 128, instead of the inner face of the sleeve 122.

The radial dynamic pressure generating grooves may be formed by means of form rolling, electrolytic etching, cutting, or the like.

In a case in which the number of radial dynamic pressure generating grooves is insufficient, this can lead to a problem of insufficient dynamic pressure. Conversely, in a case in which the number of radial dynamic pressure generating grooves is excessive, this can lead to a problem of degraded processing accuracy. Thus, the number of radial dynamic pressure generating grooves may be determined based on the optimum tradeoff. For example, in practical use, the number of radial dynamic pressure generating grooves is preferably set within a range from at least 4 to at most 12. With the embodiment, the number of first radial dynamic pressure generating grooves 144 and the number of second radial dynamic pressure generating grooves 146 are each set to 8. Such an arrangement ensures practical processing accuracy, and provides sufficient dynamic pressure.

In a case in which the radial dynamic pressure generating portion is configured to have an insufficient inside diameter, such an arrangement leads to a problem of insufficient dynamic pressure. Conversely, in a case in which the radial dynamic pressure generating portion is configured to have an excessively large inside diameter, such an arrangement can lead to a problem of increased rotation loss of the bearing. For example, the radial dynamic pressure generating portions 140 and 142 may preferably be configured to have an inside diameter within a range from at least 1.2 mm to at most 1.8 mm. It is known that such a radial dynamic pressure generating portion having an inside diameter in this range ensures that the dynamic pressure and rotation loss of the bearing are within acceptable limits. With the embodiment, the radial dynamic pressure generating portions 140 and 142 are each configured to have an inside diameter in a range between 1.5 mm and 1.6 mm. It is known that radial dynamic pressure generating portions having an inside diameter in this range ensures that the dynamic pressure and rotation loss of the bearing are within the range for practical use.

The radial dynamic pressure generating portions 140 and 142 are each configured to have a length in the axial direction in a range from at least 0.6 mm to at most 0.8 mm. It is known that radial dynamic pressure generating portions having a length in this range ensure that both the dynamic pressure and the rotation loss within the range for practical use.

The ratio of the distance in the axial direction between the outer ends of the radial dynamic pressure generating portions 140 and 142 with respect to the inside diameter of each radial dynamic pressure generating portion may be set in a range from at least 0.8 to at most 1.2. With the present embodiment, the aforementioned ratio is set to approximately 1. It is known that the aforementioned ratio set in this range ensures that such an arrangement is capable of providing sufficient dynamic pressure, and of suppressing an increase in the rotation loss of the bearing.

An expanded diameter portion is provided in the inner face of the sleeve 122 such that it is arranged between the first radial dynamic pressure generating portion 140 and the second radial dynamic pressure generating portion 142. The expanded diameter portion functions as a reservoir which reserves the lubricant agent. As an example, the expanded diameter portion is formed such that it defines a recess having a depth of 0.05 mm to 0.2 mm along the axial direction. Furthermore, as an example, the expanded diameter portion is formed to have a length of 0.1 mm to 0.3 mm along the axial direction.

A slope portion is provided to each of the radial dynamic pressure generating portions 140 and 142 formed in the inner face of the sleeve 122 such that it is provided to the outer end of each radial dynamic pressure generating portion along the axial direction. As an example, the slope portion may be configured to have a length ranging from 0.05 mm to 0.3 mm along the axial direction, and to have a slope angle ranging from 20 degrees to 70 degrees with respect to the rotational axis R.

When the rotor is relatively rotated with respect to the stator, dynamic pressure is applied to the lubricant agent 132 by means of the first radial dynamic pressure generating groove 144 and the second radial dynamic pressure generating groove 146. By applying such dynamic pressure thus generated, the rotor is supported radially in a contactless manner with respect to the stator.

A gas-liquid interface 148 of the lubricant agent 132 is formed in an upper gap 150 where the sleeve 122 and a hub 138 described later face each other. A ring-shaped sleeve recess 152 is formed in the upper face of the sleeve 122 such that it has a center that approximately matches the rotational axis R. Furthermore, a hub protrusion 154 is formed on the lower face of the hub 138 such that it is inserted into the sleeve recess 152. The gas-liquid interface 148 is formed at a position which is closer to the rotational axis R (i.e., closer to the inner side) than is the gap between the sleeve recess 152 and the hub protrusion 154. By providing the sleeve recess 152 and the hub protrusion 154, such an arrangement is capable of suppressing leakage of the lubricant agent 132.

The cover 124 is formed of a steel material such as SUS303 or the like. The cover 124 is provided to the sleeve 122 such that it covers the lower end of the sleeve 122. The thrust plate 126 is formed of resin such as a PEEK material, polyacetal, or the like. The thrust plate 126 is configured to have an approximately circular shape as viewed in a plan view. The thrust plate 126 is fixed with its edge interposed between the sleeve 122 and the cover 124. That is to say, the cover 124 presses the edge of the thrust plate 126 in contact with the sleeve 122, thereby fixing the thrust plate 126.

The thrust plate 126 is in contact with the lower end of the shaft 128, thereby supporting the shaft 128 in the axial direction. The shaft 128 has a lower end having a spherical surface that protrudes downward. The shaft 128 and the bearing assembly 104 form a ball pivot thrust bearing. By providing the thrust plate 126 formed of resin, such an arrangement provides improved rubbing resistance with respect to the rotation of the shaft 128, and provides an advantage of reduced contact friction between the thrust plate 126 and the shaft 128 (i.e., a relatively low friction coefficient).

The magnetic driving mechanism includes a flexible printed circuit board (which will be referred to as the “FPC” hereafter) 106, six coreless flat coils 108 arranged along the circumferential direction (tangential direction of a circle having a center that approximately matches the rotational axis R, which is orthogonal to the rotational axis R), and a magnet 136.

The FPC 106 is mounted on the upper face of the bottom housing 110. The FPC 106 includes an external connection portion 134 which allows it to be connected to an external power supply terminal, and an external control terminal. The electric power and the control signal, which are supplied from an external circuit via the external connection portion 134, are supplied to a driving IC described later mounted on the FPC 106, via lines formed in the FPC 106. The driving IC is connected to the six coreless flat coils 108 mounted on the FPC 106 via lines formed in the FPC 106. The driving IC supplies a current to each of the six coreless flat coils 108. By supplying three-phase current having an approximately sine wave waveform to the six coreless flat coils 108, each of the coreless flat coils 108 generates a magnetic flux along the axial direction.

The magnet 136 is configured as a ring-shaped member which surrounds the rotational axis R. The magnet 136 is fixedly bonded to the lower face of the hub 138 described later. It should be noted that, as described later, the hub 138 is formed of a ferromagnetic material. Thus, magnetic force is generated such that the magnet 136 and the hub 138 attract each other. The magnet 136 is formed by compacting a rare-earth magnet material such as a neodymium magnet material or a ferrite magnet material, for example. The surface of the magnet 136 is coated with a resin such as epoxy resin or the like, thereby forming a resin film on the surface of the magnet 136.

Ten magnetic poles are formed on the magnet 136 along the circumferential direction. Each magnetic pole generates a magnetic flux along the axial direction. Each magnetic pole faces the magnetic flux generating face of the corresponding coreless flat coil 108 along the axial direction. The magnetic interaction between each coreless flat coil 108 and the magnet 136 results in a torque applied to the magnet 136. By means of the torque thus generated, the rotor is rotated with respect to the stator.

The rotor includes the shaft 128, the hub 138, and an impeller 156.

The shaft 128 is formed by cutting, polishing, or otherwise grinding a steel base material such as SUS420J2 or the like. The shaft 128 is arranged such that it extends along the rotational axis R. A shaft hole 158 is formed in the hub 138 such that its center approximately matches the rotational axis R. The upper end of the shaft 128 is inserted into the shaft hole 158, and is fixed by means of adhesion or press fitting, or otherwise both. Thus, the shaft 128 and the hub 138 are rotated together in the form of a single unit. The hub 138 is formed by cutting or pressing a ferromagnetic base material such as SUS430 or the like.

It should be noted that the shaft 128 may be coupled with the shaft hole 158 via an interface member such as a ring-shaped bush member or the like.

The hub 138 includes: a shaft mounting portion 160 configured to surround the upper end of the shaft 128 and to be fixed to the upper end of the shaft 128, and formed such that it extends outward in the radial direction; a shaft surrounding portion 162 configured such that it protrudes downward from the outer circumferential side of the shaft mounting portion 160 so as to surround the shaft 128; and a magnet holding portion 164 configured such that it extends outward from the shaft surrounding portion 162 along the radial direction, and configured to hold the magnet 136. The shaft hole 158 is provided to the shaft mounting portion 160.

The sleeve 122 has a first outer circumferential face 166 that faces the shaft surrounding portion 162 in the radial direction, and a second outer circumferential face 168 that faces the shaft surrounding portion 162 in the axial direction. A disk-shaped gap between the second outer circumferential face 168 and the shaft surrounding portion 162, a cylindrical gap between the first outer circumferential face 166 and the shaft surrounding portion 162, the upper gap 150 between the shaft mounting portion 160 and the sleeve 122, and the radial bearing gap 130, are in communication with each other.

The impeller 156 is monolithically formed of a resin such as PBT (polybutylene terephthalate) or the like by means of plastic molding. The impeller 156 is fixed to the outer edge of the hub 138, i.e., the outer circumferential face of the magnet holding portion 164, by means of adhesion or press fitting, or otherwise both. The impeller 156 includes: a ring portion 170 arranged such that it surrounds the magnet holding portion 164, and is fixed to the magnet holding portion 164; multiple inner vanes 172 each configured to extend outward from the ring portion 170 in the radial direction; and multiple outer vanes 174 respectively configured to extend outward from the respective inner vanes 172 in the radial direction. The multiple inner vanes 172 are arranged at equal intervals along the circumference direction.

Each inner vane 172 is configured such that it protrudes upward in the axial direction, as compared with the corresponding outer vane 174 connected to the inner vane 172. In particular, each inner vane 172 is arranged such that its upper end is inserted into the top opening 116. The position of the boundary 176 between each inner vane 172 and the corresponding outer vane 174 connected to the inner vane 172 corresponds to that of the edge of the top opening 116.

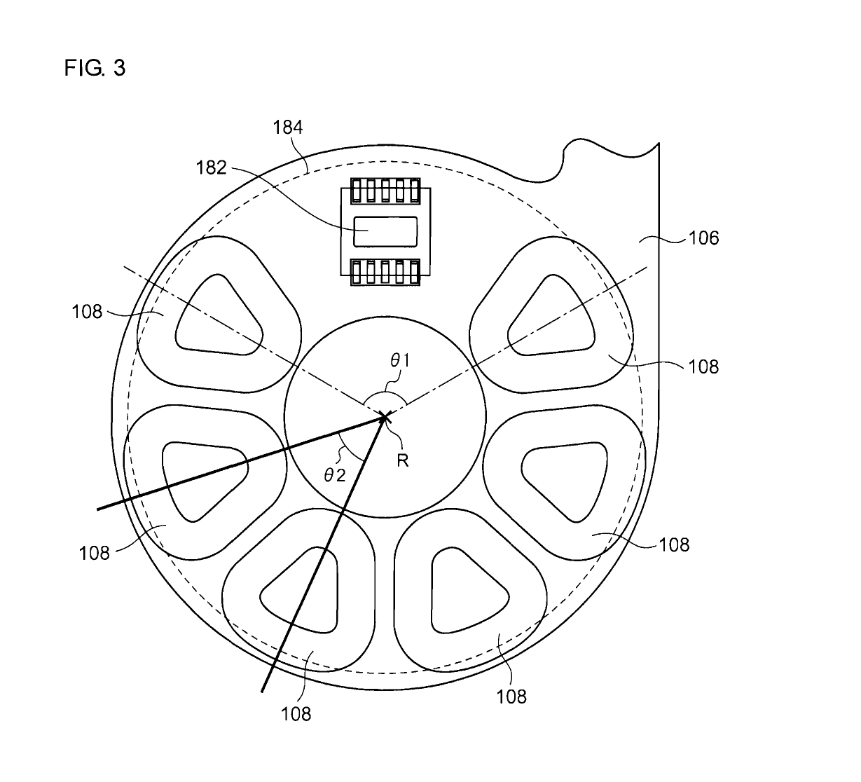

FIG. 3 is a top view of the six coreless flat coils 108 arranged on the FPC 106. The coreless flat coils 108 are fixed to the upper face of the FPC 106 by means of adhesion. Both terminals (not shown) of the coreless flat coils 108 are electrically connected to lines of the FPC 106 by means of soldering. Each coreless flat coil 108 is configured as an air-core coil having an approximately trapezoidal shape as viewed in a plan view. Each coreless flat coil 108 is formed by winding a self-bonding wire.

The six coreless flat coils 108 are arranged in a rotationally asymmetric manner with respect to the rotational axis R. The angle which represents the difference between the angular position of a coreless flat coil 108 and the angular position of the adjacent coreless flat coil 108 with the rotational axis R as the reference axis will be referred to hereafter as the “coil pitch angle”. Six coil pitch angles can be defined with respect to the six coreless flat coils 108. With the present embodiment, one coil pitch angle θ1 is greater than those of the other five coreless flat coils 108. The coil pitch angles of the other five coreless flat coils 108 are approximately the same, i.e., approximately equal to θ2. Specifically, the aforementioned one coil pitch angle θ1 is 120 degrees. The coil pitch angle θ2, which is set for the other five coil pitch angles, is 48 degrees.

A driving IC 182 which supplies electric power to the six coreless flat coils 108 is mounted at a portion on the upper face of the FPC 106 such that it is arranged between two adjacent coreless flat coils 108. In particular, the driving IC 182 is arranged between the two adjacent coreless flat coils 108 which define the greater coil pitch angle θ1 along the circumferential direction.

Description will be made regarding the mounting position of the driving IC 182 in the radial direction. The driving IC 182 is arranged at a position more toward the inner side than is the impeller 156. That is to say, the driving IC 182 is arranged at a position that avoids it being positioned in a region between the impeller 156 and the bottom housing 110. The broken circle 184 shown in FIG. 3 indicates the inner circumferential face of the impeller 156. The driving IC 182 is arranged more toward the inner side than is the broken circle 184, i.e., on the side that is closer to the rotational axis R. Moreover, the impeller 156 is positioned more toward the outer side than is the broken circle 184. Thus, the driving IC 182 is not arranged at a position where it is interposed between the impeller 156 and the bottom housing 110.

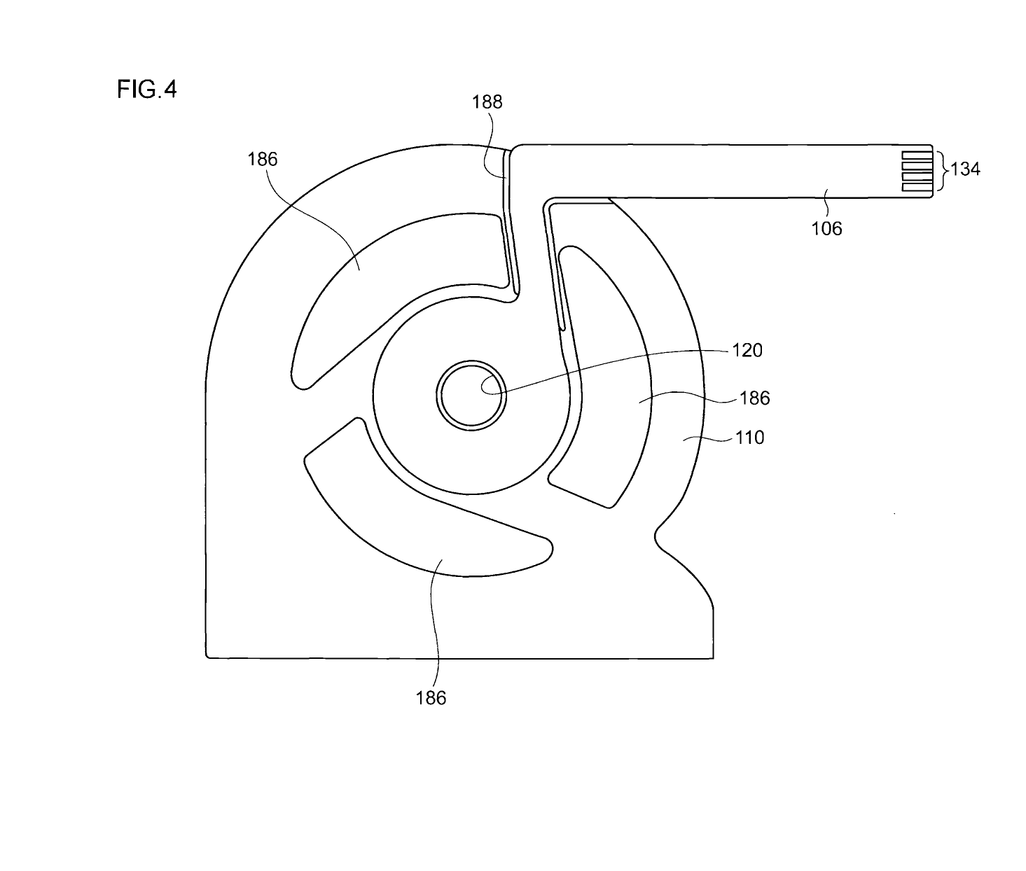

FIG. 4 is a top view of the FPC 106 fixed on the bottom housing 110. Three bottom vent holes 186 are formed in the bottom housing 110. A bottom recess portion 188 is formed in the upper face of the bottom housing 110 such that it extends along the path via which the FPC 106 is to be arranged. The FPC 106 is housed in the bottom recess portion 188. The bottom recess portion 188 is formed by cutting or pressing the bottom housing 110.

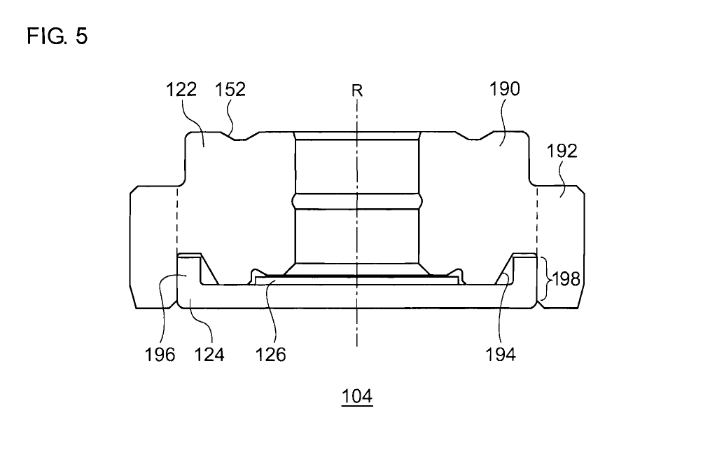

FIG. 5 is a cross-sectional diagram showing the bearing assembly 104. The sleeve 122 includes an inner portion 190 which surrounds the shaft 128, and an outer portion 192 which surrounds the inner portion 190. The inner portion 190 and the outer portion 192 define a cover recess portion 194 on the side of their lower faces in the vicinity of the boundary between the inner portion 190 and the outer portion 192. The outer edge of the cover 124 is bent upward. Such a portion 196 thus bent upward is fixed to the cover recess portion 194 by means of press fitting, or otherwise by means of both press fitting and adhesion. With the latter method, an adhesive agent also functions as a sealing agent which prevents leakage of the lubricant agent 132.

As described above, the bearing assembly 104 is configured such that a region 198 where the cover 124 and the sleeve 122 face each other along the radial direction and are in contact with each other surrounds the lower end of the shaft 128 and the thrust plate 126. Thus, even in a case in which the region 198 is configured to have an increased length in the axial direction, the overall thickness of the bearing assembly 104 does not increase to a significant extent. Thus, such an arrangement provides improved bonding strength between the cover 124 and the sleeve 122 while suppressing an increase in the overall thickness of the bearing assembly 104.

Description will be made regarding the operation of the fan motor 100 having the aforementioned configuration. In order to rotate the impeller 156, the driving IC 182 supplies three-phase current to the six coreless flat coils 108. The current flows through the coreless flat coils 108, thereby generating a magnetic flux at each coreless flat coil 108. The magnetic flux thus generated applies a torque to the magnet 136, thereby rotating the impeller 156. By means of the rotation of the impeller 156, air is discharged via the vent 180.

With the fan motor 100 according to the present embodiment, such an arrangement allows the thickness of the fan motor 100 to be further reduced while suppressing degradation of ventilation performance and degradation of power consumption. Specifically, the fan motor 100 can be configured with a thickness T1 (see FIG. 2) of 3.2 mm or less along the rotational axis R. The major factors which contribute to the configuration of the fan motor 100 having such a small thickness will be listed below.

(A) A part of each vane of the impeller 156 penetrates the top opening 116. That is to say, the top housing 112 and each inner vane 172 are overlapping. Thus, such an arrangement allows the fan motor 100 to be configured with a reduced thickness while suppressing a reduction in the area of the ventilating face of each vane.

(B) Employing an axially-opposing type magnetic driving mechanism using the coreless flat coils 108 allows the thickness of the fan motor 100 to be further reduced by the absence of cores.

(C) A fluid dynamic pressure bearing is employed.

(D) The FPC 106 is housed in the bottom recess portion 188. Basically, such an arrangement allows the overall thickness of the fan motor 100 to be reduced by the thickness of the FPC 106.

In a case in which the fan motor 100 is mounted on a laptop PC or a tablet PC, typically, the fan motor 100 is arranged between an LCD (Liquid Crystal Display) panel and a bottom plate. From the viewpoint of a demand for a reduced-thickness electronic device, let us consider an arrangement in which the thickness from the upper face of the LCD panel to the lower face of the bottom plate is 9 mm or less. The typical thickness of each of the components other than the fan motor 100 and the typical length of each gap will be listed below.

The thickness of the LCD panel=4 mm.

The thickness of the bottom plate=0.6 mm.

The gap length between the fan motor 100 and the LCD panel=0.6 mm.

The gap length between the fan motor 100 and the bottom plate=0.6 mm.

Thus, such an arrangement requires the fan motor 100 to have a thickness of 3.2 mm or less. The fan motor 100 surely satisfies this requirement. As described above, the fan motor 100 is suitably mounted on electronic devices that are demanded to have a reduced thickness.

Furthermore, with the fan motor 100 according to the present embodiment, by providing the disk-shaped gap and the cylindrical gap between the shaft surrounding portion 162 and the sleeve 122, such an arrangement provides increased air resistance in the path from the gas-liquid interface 148 of the lubricant agent 132 up to the external atmosphere. This reduces the speed of evaporation of the lubricant agent 132 and suppresses leakage thereof, thereby improving the life of the fan motor 100.

Furthermore, with the fan motor 100 according to the present embodiment, the driving IC 182 is arranged at a position that is more toward the inner side than is the impeller 156. Thus, the driving IC 182 is arranged at a position that avoids it being positioned in a region between the impeller 156 and the bottom housing 110. With the centrifugal ventilation type fan motor 100, the position of the driving IC 182 is outside the main path of the air flow generated by the rotation of the impeller 156. Thus, such an arrangement allows the effect of the casing of the driving IC 182 on the air flow to be reduced.

In particular, in a case in which the fan motor is configured to have a reduced thickness, the relative thickness of the driving IC becomes large. Thus, as the thickness of the fan motor becomes smaller, the aforementioned advantage of a reduced effect on the air flow becomes more pronounced.

With the fan motor 100 according to the present embodiment, the coreless flat coils 108 are not necessarily required to be arranged so as to have rotational symmetry with respect to the rotational axis R. In light of this, the driving IC 182 is arranged such that it is interposed between two coreless flat coils 108 adjacent to each other along the circumferential direction. Thus, such an arrangement allows the driving IC 182 to be arranged closer to the rotational axis R.

Description has been made regarding the configuration and the operation of the fan motor 100 according to the embodiment. The above-described embodiments have been described for exemplary purposes only, and are by no means intended to be interpreted restrictively. Rather, it can be readily conceived by those skilled in this art that various modifications may be made by making various combinations of the aforementioned components, which are also encompassed in the technical scope of the present invention.

Description has been made in the embodiment regarding an arrangement in which the bearing assembly 104 is fixed to the bottom housing 110, and the shaft 128 is rotated with respect to the bearing assembly 104. However, the present invention is not restricted to such an arrangement. For example, the technical idea according to the present embodiment can be applied to a fixed-shaft type fan motor having a configuration in which the shaft is fixed to the bottom housing, and the bearing assembly is rotated together with the hub with respect to the shaft.

Description has been made in the embodiment regarding an arrangement employing the six coreless flat coils 108. However, the present invention is not restricted to such an arrangement. Various combinations may be employed among the number of magnet poles and the number of coils. Examples of such combinations include four poles and six coils, eight poles and six coils, twelve poles and six coils, ten poles and six coils, twelve poles and nine coils, and the like. Such a combination may preferably be selected based on a space where the driving IC is to be arranged, the size of the fan motor 100, the electrical characteristics of the fan motor 100, and so forth.

Description has been made in the embodiment regarding an arrangement in which the bottom recess portion 188 is formed by cutting or otherwise pressing the bottom housing 110 configured as a single plate. However, the present invention is not restricted to such an arrangement. For example, the bottom housing may have a multi-layer structure. In this case, the bottom recess portion corresponds to a notch formed in the layer that corresponds to the surface of the bottom housing.

A bottom housing 210 according to a first modification has a double layer structure in which a lower layer 214 is adhered to an upper layer 212.

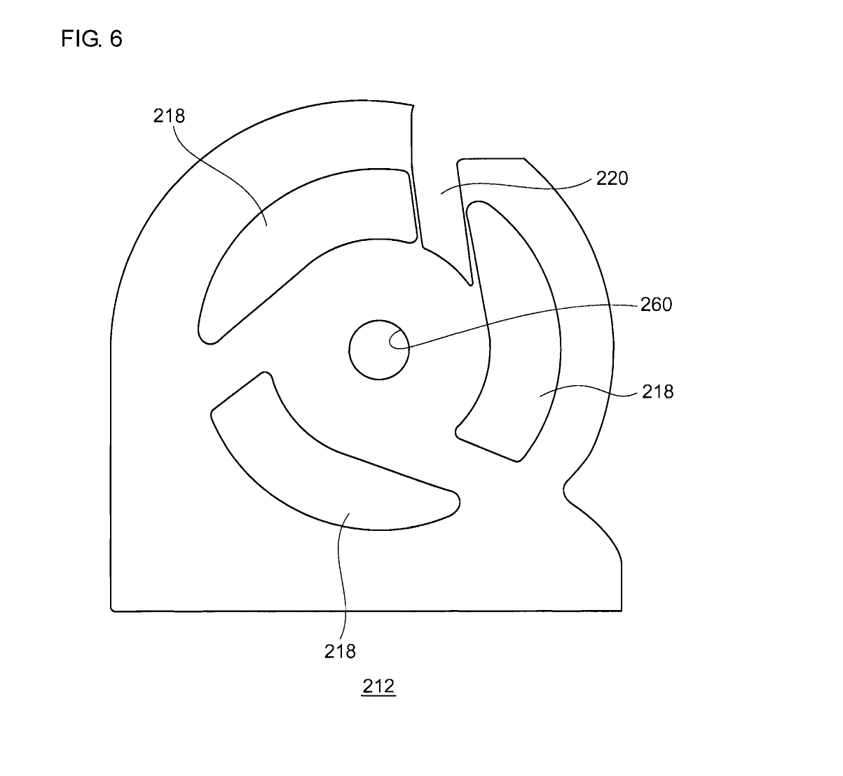

FIG. 6 is a top view of the upper layer 212. In the upper layer 212, upper vent holes 218 that correspond to the three bottom vent holes 186, an upper notch 220 that corresponds to the bottom recess portion 188, and an upper bearing hole 260 that corresponds to the bearing hole 120 are formed.

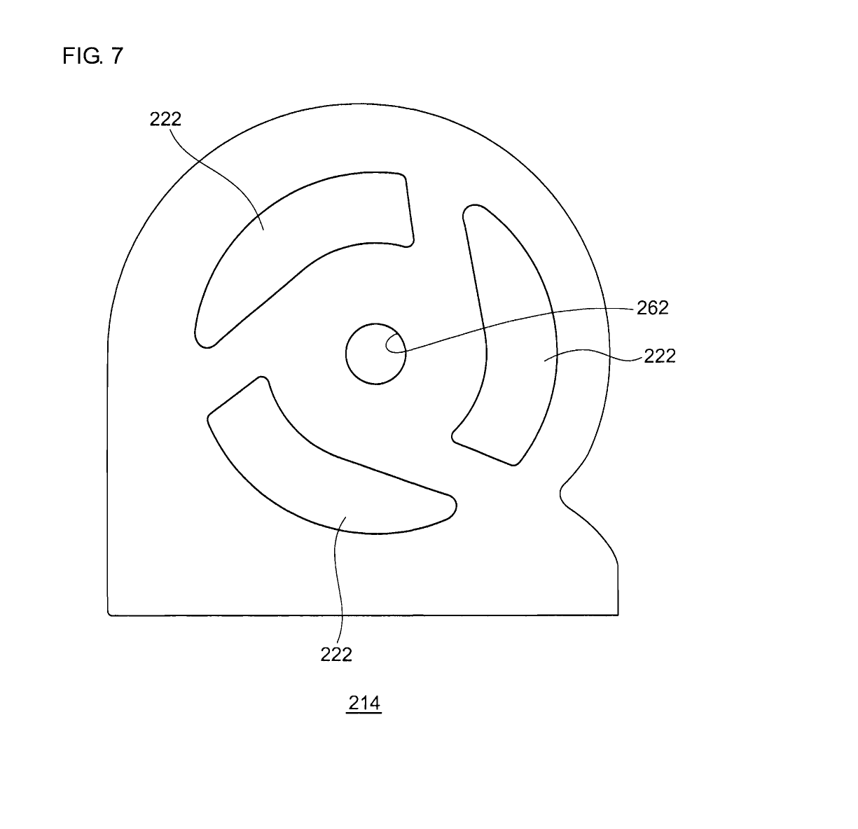

FIG. 7 is a top view of the lower layer 214. In the lower layer 214, lower vent holes 222 that correspond to the three bottom vent holes 186 and a lower bearing hole 262 that corresponds to the bearing hole 120 are formed.

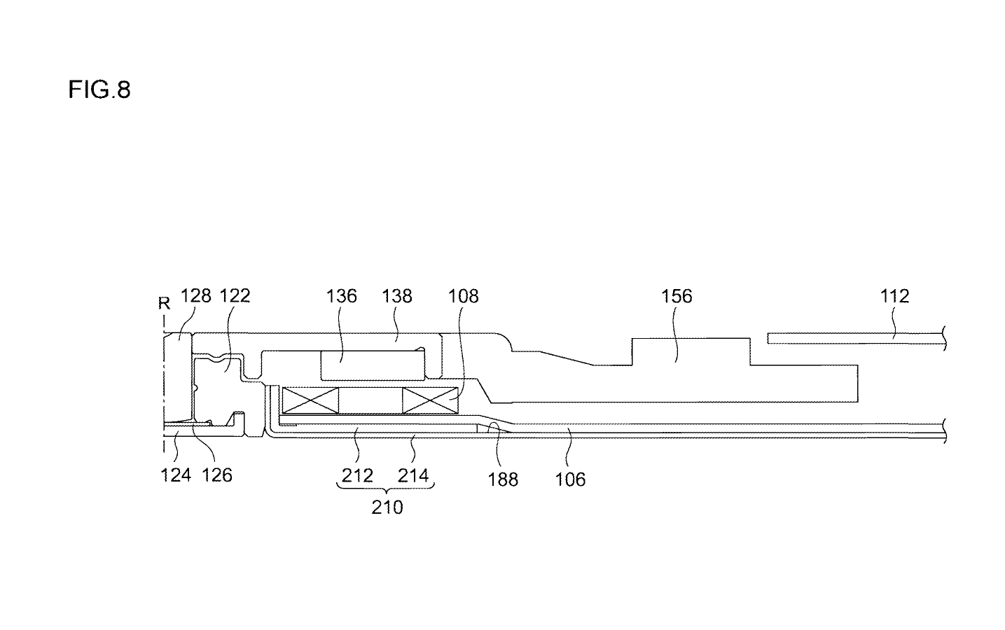

FIG. 8 is a half cross-sectional diagram showing a fan motor including the bottom housing 210 according to the first modification.

By coupling the upper layer 212 and the lower layer 214 to each other by means of swaging or adhesion, the bottom housing 210 can be formed to have the same configuration as that of the bottom housing 110.

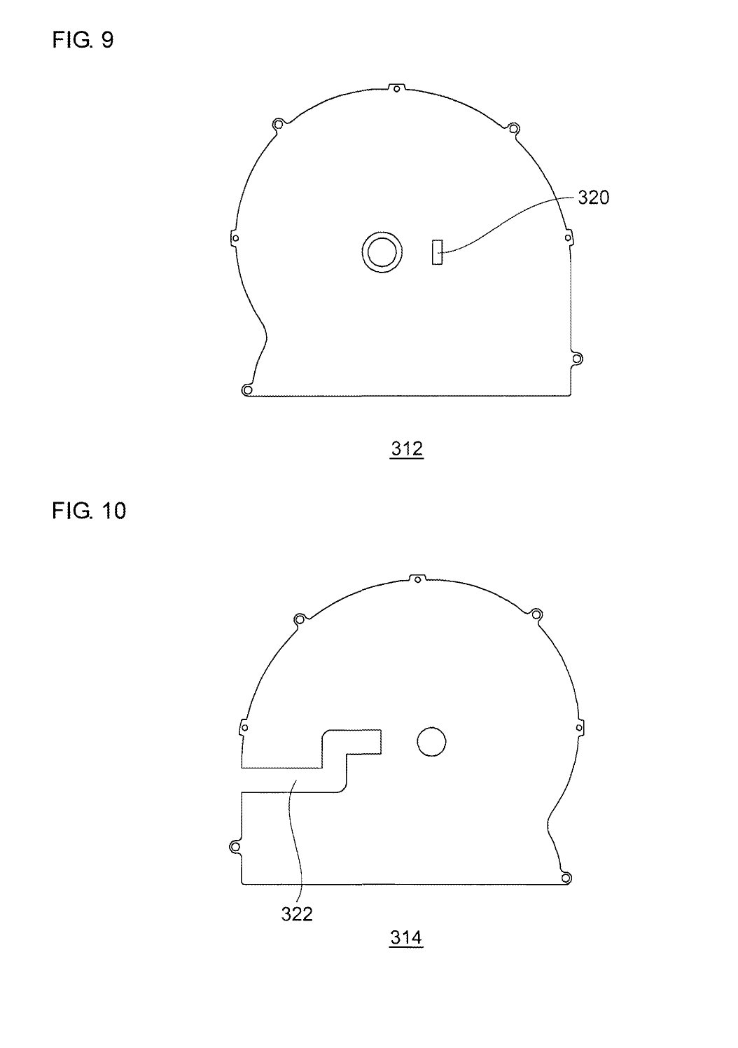

FIG. 9 is a top view of an upper layer 312 of a bottom housing 310 according to a second modification. A first through hole 320 is formed in the upper layer 312 by means of press cutting.

FIG. 10 is a bottom view of a lower layer 314 of the bottom housing 310. A first notch 322 is formed in the lower layer 314 by means of press cutting.

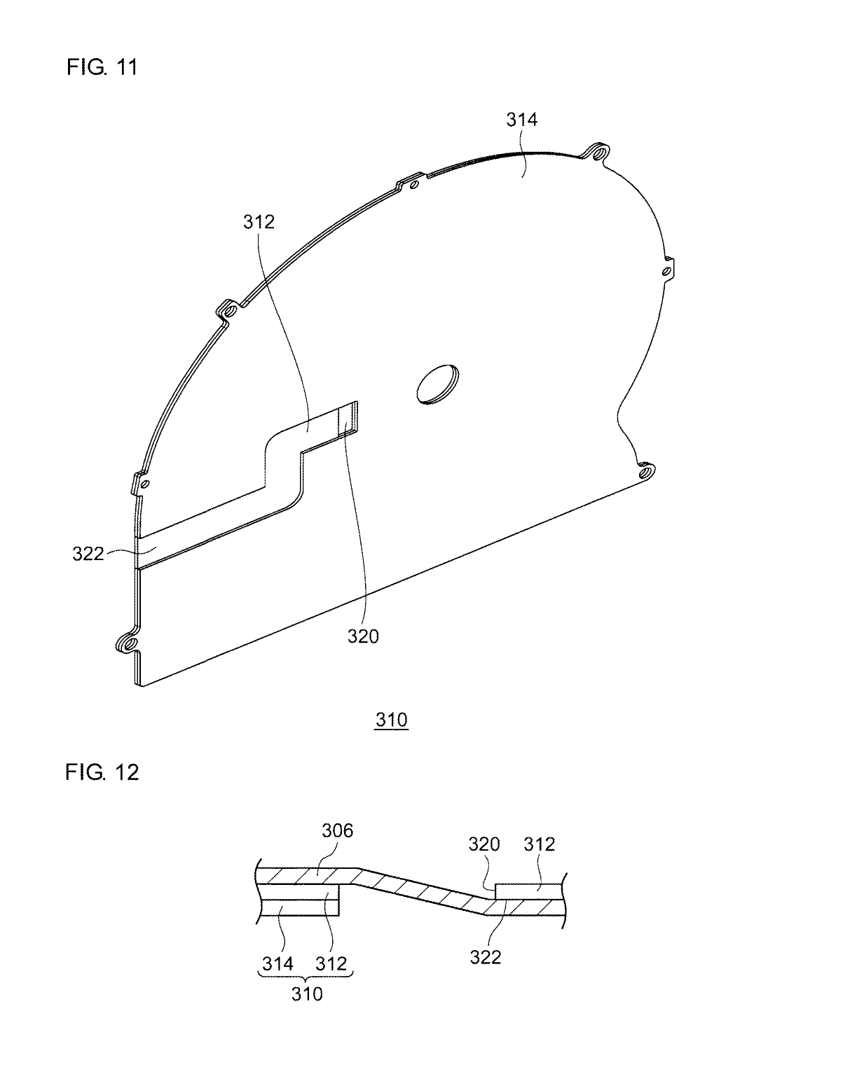

FIG. 11 is a perspective view of the bottom housing 310. FIG. 12 is a cross-sectional diagram showing a portion of the bottom housing 310 on which the FPC 306 is mounted in the vicinity of the first through hole 320. The upper layer 312 and the lower layer 314 are coupled to each other by means of swaging or adhesion, thereby forming the bottom housing 310. The bottom recess portion defined by the first notch 322 on the lower face of the bottom housing 310 houses an FPC 306. The first through hole 320 communicates with the first notch 322. The FPC 306 is drawn out on the upper face of the bottom housing 310 after it passes through the first through hole 320.

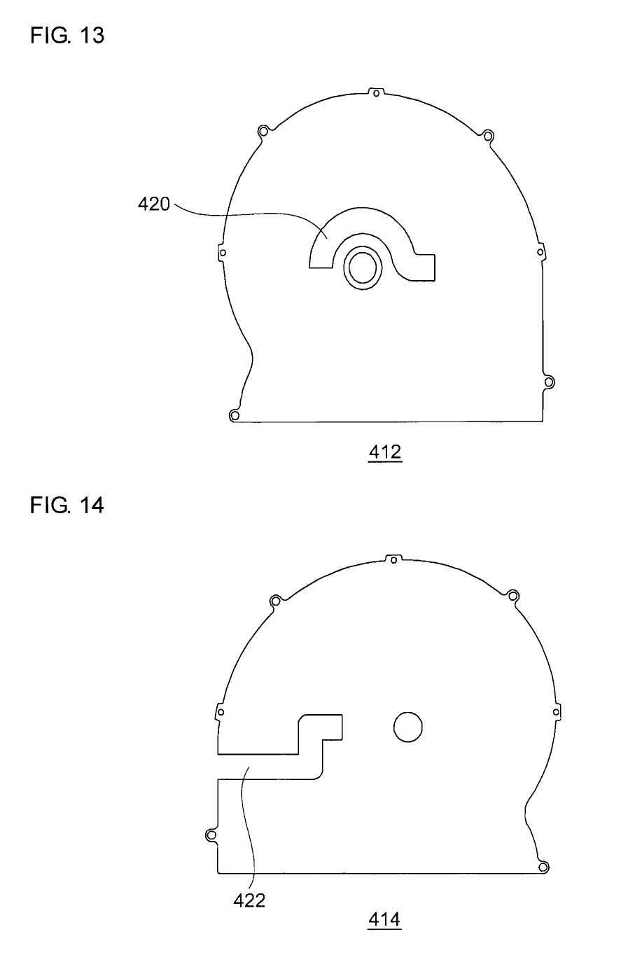

FIG. 13 is a top view of an upper layer 412 of a bottom housing 410 according to a third modification. A second through hole 420 is formed in the upper layer 412 by means of press cutting.

FIG. 14 is a bottom view of a lower layer 414 of the bottom housing 410. A second notch 422 is formed in the lower layer 414 by means of press cutting.

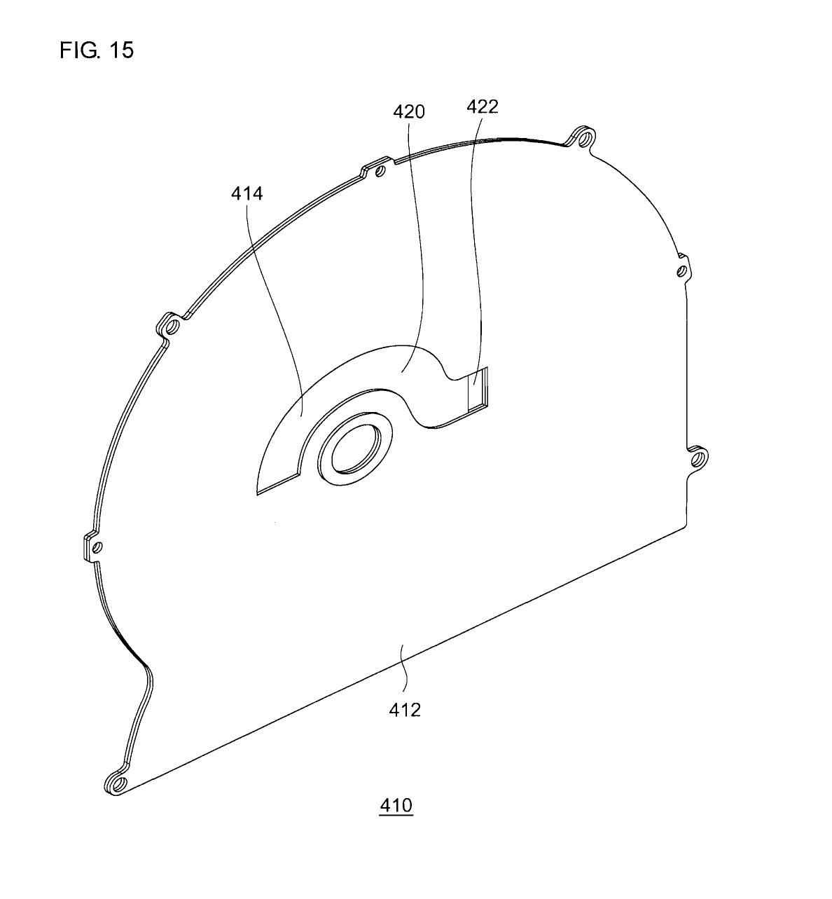

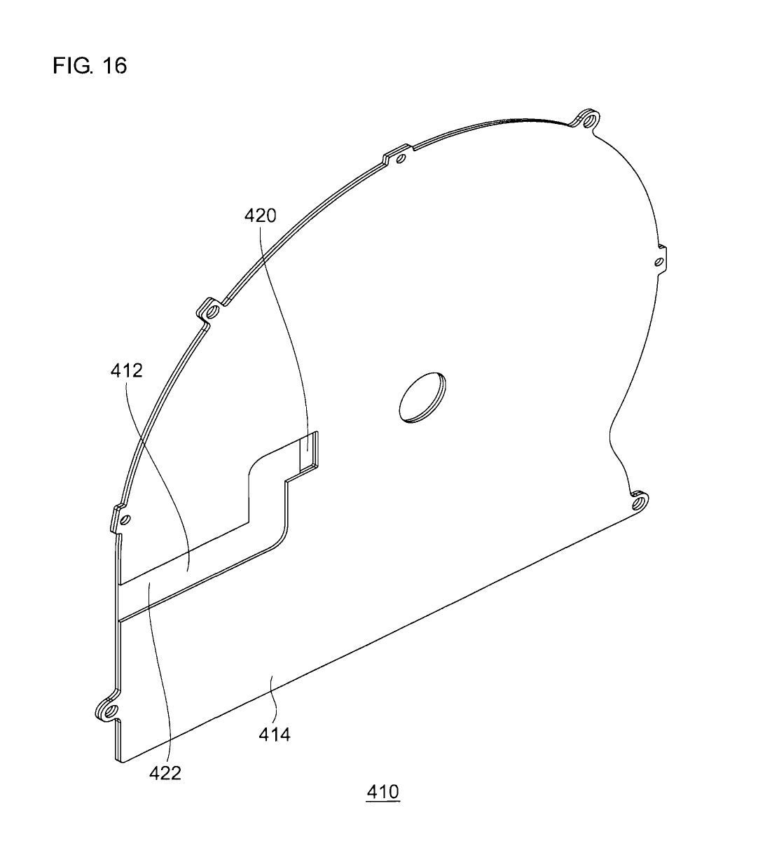

FIG. 15 is a perspective view of the bottom housing 410 as viewed from the top side. FIG. 16 is a perspective view of the bottom housing 410 as viewed from the bottom side.

In a case in which such a bottom recess portion is formed by cutting or pressing a bottom housing configured as a single plate, there is a need to provide the surface of the bottom housing having a relatively small thickness with a recess portion which is not a through hole. Such a process requires relatively high machining accuracy. In contrast, with the first through third modifications, basically, such a recess portion can be formed by providing a hole or notch to a plate member. Although such modifications requires the layer coupling process as a tradeoff, such modifications allow the bottom housing to be formed in a simpler manner, thereby providing a reduced cost.

Also, with the first through third modifications, the depth of the bottom recess portion is determined by the thickness of the upper layer itself or otherwise the lower layer itself, thereby suppressing variations in the depth of the bottom recess portion. Also, with the first through third modifications, the fan motor has a configuration in which the coreless flat coils 108 are mounted on a plate having a multi-layer structure. Such a configuration reduces energy loss due to eddy current, thereby providing improved electrical efficiency.

Description has been made in the embodiment regarding an arrangement in which the sleeve 122 is configured as a single member. However, the present invention is not restricted to such an arrangement. For example, the sleeve may have a porous portion formed of a porous material such as sintered metal or the like and a non-porous portion formed of a non-porous material. With such an arrangement, the porous portion is impregnated with the lubricant agent. The porous portion is formed to have a surface that faces the gap between the sleeve and the shaft.

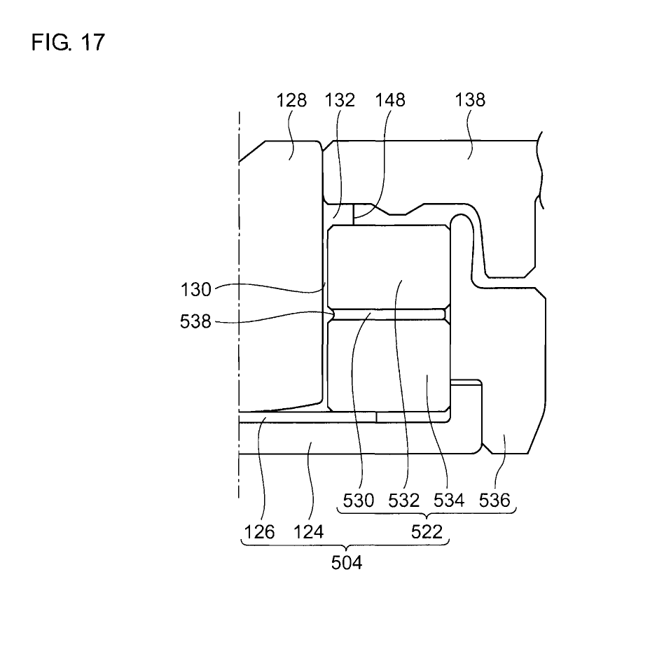

FIG. 17 is a half cross-sectional diagram showing a bearing assembly 504, a shaft 128, and a hub 138, according to a fourth modification. The bearing assembly 504 includes a cover 124, a thrust plate 126, and a sleeve 522. The sleeve 522 includes: an impregnation portion 530 formed of sintered metal; an upper portion 532 and a lower portion 534 arranged such that the impregnation portion 530 is interposed between them in the axial direction; and an outer portion 536 which surrounds the impregnation portion 530. The impregnation portion 530 is configured to have a disk shape and to have an inner circumferential face 538 that faces the radial bearing gap 130. The impregnation portion 530 is impregnated with the lubricant agent 132 via the inner circumferential face 538.

The present modification allows the fan motor to hold an increased amount of the lubricant agent 132. As a result, such an arrangement improves the life of the fan motor in relation to the amount of the lubricant agent 132.

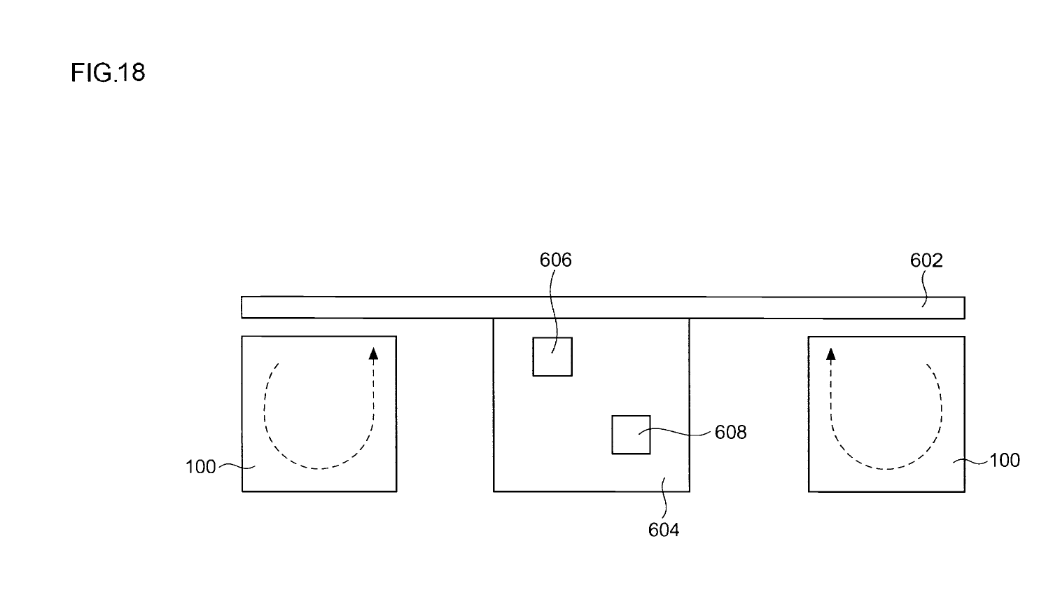

Multiple fan motors 100 according to the embodiment may be mounted on a portable electronic device. FIG. 18 is a schematic diagram showing two fan motors 100 according to the embodiment mounted on a laptop PC. FIG. 18 is a diagram showing the internal configuration of the laptop PC as viewed from the back. In FIG. 18, other components such as a battery are not shown for ease of description.

Ventilation air generated by the two fan motors 100 is blown onto a heat-transfer bar 602 formed of a metal material. One of the fan motors 100 blows air onto one end of the heat-transfer bar 602, and the other fan motor 100 blows air onto the other end of the heat-transfer bar 602. The two fan motors 100 are configured such that their rotational axes are arranged approximately in parallel with each other. Furthermore, the two fan motors 100 are configured such that their impellers are rotationally driven in different rotational directions that are the reverse of each other.

An intermediate portion of the heat-transfer bar 602 is mounted on a substrate 604. ICs such as a CPU 606, memory 608, and the like, are mounted on the substrate 604. The two fan motors 100 indirectly cool these ICs via the heat-transfer bar 602.

What is claimed is:

1. A fan motor comprising:
a first rotor configured to be rotated so as to generate air movement;
a stator configured to rotatably support the first rotor via a fluid dynamic pressure bearing; and
a driving mechanism configured to rotationally drive the first rotor with respect to the stator,
wherein the first rotor comprises a hub and a vane member fixed to the hub,
wherein the stator comprises a base which supports the driving mechanism,
and wherein the fan motor is configured to have a thickness of 3.2 mm or less along a rotational axis of the first rotor.

2. The fan motor according to claim 1, wherein the driving mechanism comprises:
a magnetic flux generating unit fixed to the base, and configured to generate a magnetic flux along a rotational axis direction; and
a magnet fixed to the hub so as to face the magnetic flux generating unit in the rotational axis direction.

3. The fan motor according to claim 2, wherein the magnetic flux generating unit comprises six or nine coils arranged along a circumferential direction,
wherein a plurality of magnetic poles are formed on the magnet along the circumferential direction,
and wherein the hub is formed of a magnetic material.

4. The fan motor according to claim 1, wherein the first rotor comprises a shaft configured to extend along the rotational axis of the first rotor, and to be rotated together with the hub,
wherein the stator comprises a sleeve configured to surround the shaft via a lubricant agent,
wherein the hub comprises:
a first portion fixed so as to surround one end of the shaft, to be fixed to the aforementioned one end of the shaft, and to extend along a radial direction; and
a second portion configured to surround the shaft, and to protrude from an outer circumferential side of the first portion,
wherein the sleeve comprises:
a first outer face that faces the second portion in the radial direction; and
a second outer face that faces the second portion in a rotational axis direction,
and wherein a first gap between the second portion and the second outer face, a second gap between the second portion and the first outer face, a third gap between the sleeve and the first portion, and a fourth gap between the sleeve and the shaft are in communication with each other.

5. The fan motor according to claim 1, wherein the vane member comprises:
a ring portion configured to surround the hub, and to be fixed to the hub;
an inner vane configured to extend outward from the ring portion in a radial direction; and
an outer vane configured to extend outward from the inner vane in the radial direction.

6. The fan motor according to claim 5, wherein the stator comprises a cover that faces the base in a rotational axis direction,
wherein an opening is provided to the cover so as to surround the rotational axis of the first rotor,
wherein the inner vane has a portion which is inserted into the opening of the cover,
and wherein a boundary between the inner vane and the outer vane corresponds to the edge of the opening of the cover.

7. The fan motor according to claim 1, wherein the stator comprises:
a cover configured to face the base in a rotational axis direction; and
a side wall portion configured to support the cover with respect to the base,
wherein the base, the cover, and the side wall portion define a housing space for housing the first rotor,
wherein an opening is provided to the cover so as to surround the rotational axis of the first rotor,
wherein the side wall portion is configured to surround a part of the first rotor,
and wherein, during the rotation of the first rotor, air passes through a side opening formed at the side wall.

8. The fan motor according to claim 1, further comprising a wiring member configured to supply electric power to the driving mechanism,
wherein a recess portion is provided to the base along the wiring member,
and wherein at least a part of the wiring member is housed in the recess portion.

9. The fan motor according to claim 1, further comprising a second rotor configured to be rotated so as to generate air movement,
wherein a rotational axis of the second rotor is approximately in parallel with the rotational axis of the first rotor,
and wherein, during the rotation of the two rotors, the second rotor rotates in a rotational direction that is the reverse of the rotation of the first rotor.

10. A fan motor comprising:
a rotor configured to be rotated so as to generate air movement;
a stator configured to rotatably support the rotor via a fluid dynamic pressure bearing;
a driving mechanism configured to rotationally drive the rotor with respect to the stator; and
an integrated circuit configured to supply electric power to the driving mechanism,
wherein the rotor comprises a hub and a vane member fixed to the hub,
wherein the stator comprises a base which supports the driving mechanism,
and wherein the integrated circuit is arranged at a position where the integrated circuit is more toward an inner side than is the vane member, so as to avoid the integrated circuit being positioned at a region between the vane member and the base.

11. The fan motor according to claim 10, wherein the driving mechanism comprises:
a magnetic flux generating unit fixed to the base, and configured to generate a magnetic flux; and
a magnet fixed to the hub so as to face the magnetic flux generating unit in a rotational axis direction.

12. The fan motor according to claim 11, wherein the magnetic flux generating unit comprises a plurality of coils arranged along a circumferential direction,
wherein a plurality of magnetic poles are formed on the magnet along the circumferential direction,
wherein the plurality of coils are arranged in a rotationally asymmetric manner with respect to a rotational axis of the rotor,
and wherein the integrated circuit is arranged between the adjacent coils.

13. The fan motor according to claim 10, wherein the rotor comprises a shaft configured to extend along a rotational axis of the rotor, and to be rotated together with the hub,
wherein the stator comprises a sleeve configured to surround the shaft via a lubricant agent,
wherein the hub comprises:
a first portion fixed so as to surround one end of the shaft, to be fixed to the aforementioned one end of the shaft, and to extend along a radial direction; and
a second portion configured to surround the shaft, and to protrude from an outer circumferential side of the first portion,
wherein the sleeve comprises:
a first outer face that faces the second portion in the radial direction; and
a second outer face that faces the second portion in a rotational axis direction,
and wherein a first gap between the second outer face and the second portion, a second gap between the first outer face and the second portion, a third gap between the first portion and the sleeve, and a fourth gap between the shaft and the sleeve are in communication with each other.

14. The fan motor according to claim 10, wherein the vane member comprises:
a ring portion configured to surround the hub and to be fixed to the hub;
an inner vane configured to extend outward from the ring portion in a radial direction; and
an outer vane configured to extend outward from the inner vane in the radial direction.

15. The fan motor according to claim 10, further comprising a wiring member configured to transmit electric power to be supplied to the driving mechanism,
wherein a recess portion is provided to the base so as to extend along a path along which the wiring member is arranged,
and wherein at least a part of the wiring member is housed in the recess portion.

16. A fan motor comprising:
a rotor configured to be rotated so as to generate air movement;
a stator configured to rotatably support the rotor via a fluid dynamic pressure bearing;
a driving mechanism configured to rotationally drive the rotor with respect to the stator; and
a wiring member configured to transmit electric power to be supplied to the driving mechanism,
wherein the rotor comprises a hub and a vane member fixed to the hub,
wherein the stator comprises a base which supports the driving mechanism,
and wherein the base includes a plurality of layers.

17. The fan motor according to claim 16, wherein a notch is provided to a surface layer of the plurality of layers along the wiring member,
wherein at least a part of the wiring member is housed in a notch.

18. The fan motor according to claim 16, wherein the driving mechanism comprises:
a magnetic flux generating unit fixed to the base, and configured to generate a magnetic flux; and
a magnet fixed to the hub so as to face the magnetic flux generating unit in a rotational axis direction.

19. The fan motor according to claim 18, wherein the magnetic flux generating unit comprises six or nine coils arranged along a circumferential direction,
wherein a plurality of magnetic poles are formed on the magnet along the circumferential direction,
and wherein the hub is formed of a magnetic material.

20. The fan motor according to claim 16, wherein the rotor comprises a shaft configured to extend along a rotational axis of the rotor, and to be rotated together with the hub,
wherein the stator comprises a sleeve configured to surround the shaft via a lubricant agent,
wherein the hub comprises:
a first portion fixed so as to surround one end of the shaft, to be fixed to the aforementioned one end of the shaft, and to extend along a radial direction; and
a second portion configured to surround the shaft, and to protrude from an outer circumferential side of the first portion,
wherein the sleeve comprises:
a first outer face that faces the second portion in the radial direction; and
a second outer face that faces the second portion in a rotational axis direction,
and wherein a first gap between the second outer face and the second portion, a second gap between the first outer face and the second portion, a third gap between the first portion and the sleeve, and a fourth gap between the shaft and the sleeve are in communication with each other.
